(19) United States
(12) Patent Application Publication
(10) Pub. No.: US 2003/0001690 A1
(43) Pub. Date: Jan. 2, 2003

(54) Dielectric duplexer and communication device

(76) Inventors: Katsuhito Kuroda, Matsutou-shi (JP); Jinsei Ishihara, Kanazawa-shi (JP); Hideyuki Kato, Ishikawa-ken (JP)

Correspondence Address: Richard LaCava, DICKSTEIN SHAPIRO MORIN & OSHINSKY LLP, 41st Floor, 1177 Avenue of the Americas, New York, NY, 10036-2714, US

(21) Appl. No.: 10/180,250

(22) Filed: Jun. 26, 2002

(30) Foreign Application Priority Data
Jun. 27, 2001 (JP) 2001-194513
Apr. 17, 2002 (JP) 2002-114867

(51) Int. Cl. H01P 5/12

(52) U.S. Cl. 333/134

(57) ABSTRACT

A dielectric duplexer which includes a dielectric block having a plurality of conductive through holes and an antenna excitation hole. On the outer surface of the dielectric block, an outer conductor, an input terminal, an output terminal, and an antenna terminal are provided. The input terminal, the output terminal, and the antenna terminal are separated from the outer conductor. The antenna terminal is electrically coupled with the antenna excitation hole. The absolute value of the reflection coefficient of at least one of the input terminal, the output terminal, and the antenna terminal is in the range of about 0.33 to about 1.00 in a passband, with a reference impedance of 50 Ω.

### BACKGROUND OF THE INVENTION

1. Field of the Invention

The present invention relates to a dielectric duplexer mainly used in RF circuits for mobile communication and to a communication device having the dielectric duplexer.

2. Description of the Related Art

Typically, a communication device having a dielectric duplexer is configured with elements as shown in FIGS. 13A and 13B.

FIG. 13A is a block diagram of a communication device of the related art, and FIG. 13B is a block diagram of another communication device of the related art in which matching circuits are inserted. Referring to FIGS. 13A and 13B, reference symbol DPX indicates a duplexer, ANT is an antenna, PA is a power amplifier, and LNA is a low-noise amplifier.

In general, an impedance system in a transmission line for a radio frequency signal is set to 50 Ω as a reference. Thus, a dielectric duplexer is also commonly configured so as to match with such a reference impedance system.

As shown in FIG. 13A, in a typical portable communication device, in many cases, the power amplifier PA is connected to a TX terminal of the dielectric duplexer DPX, the antenna ANT is connected to an ANT terminal, and the low-noise amplifier LNA is connected to an RX terminal.

A signal amplified by the power amplifier PA is sent to the antenna ANT through the dielectric duplexer DPX, and is sent out from the antenna ANT. A signal received by the antenna ANT is sent to the low-noise amplifier LNA through the duplexer DPX, amplified, and then sent to a circuit at a subsequent stage.

However, such a dielectric duplexer of the related art and such a communication device having the dielectric duplexer exhibit the following problems.

An element connected to a duplexer for use in a communication device does not necessarily have an impedance of 50 Ω, and often has an impedance that deviates therefrom.

Since a portable communication device uses a battery as its power supply, a power amplifier PA provided in the portable communication device and connected to the input terminal (TX terminal) of a duplexer is set to have a low power-supply voltage, which is generally about 3 to 6 V. Thus, for increasing an output to be transmitted from the antenna, the output impedance must be set low. For example, the output impedance required for providing a saturation power of about 2 W is about 2 to 6 Ω. However, when a power amplifier PA having an output impedance of 2 to 6 Ω is directly connected to the duplexer, since the input impedance of the duplexer is 50 Ω, no impedance matching is achieved, resulting in the generation of loss due to signal return.

Thus, as shown in FIG. 13B, a matching circuit for performing impedance matching is inserted between the power amplifier PA and the duplexer DPX such that the 2 to 6 Ω transmission system is converted into a 50 Ω transmission system to transmit a signal.

In addition to loss that resulted from the matching circuit itself, the insertion of the matching circuit causes the generation of other transmission loss between the power amplifier PA and the matching circuit, and between the matching circuit and the duplexer DPX. Furthermore, such an arrangement requires additional space for arranging the matching circuit, thus causing an increase in the size of the device.

The low-noise amplifier LNA connected to the output terminal (RX terminal) of the duplexer DPX typically has an input impedance of about 100 Ω, thus requiring matching with the duplexer DPX. Also in this case, the insertion of a matching circuit causes the generation of various types of loss, such as those described above, making it difficult to achieve low-loss transmission of a signal.

### SUMMARY OF THE INVENTION

Accordingly, an object of the present invention is to provide a dielectric duplexer that facilitates impedance matching between the duplexer and each circuit element connected thereto without the use of an additional circuit element, and to provide a communication device having the dielectric duplexer.

According to one aspect of the present invention, there is provided a dielectric duplexer. The dielectric duplexer includes a dielectric block preferably having a substantially rectangular shape. In the dielectric block, a plurality of holes, each having an inner conductor on the inner surface thereof, are provided so as to extend from one surface of the dielectric block to the opposing surface thereof so as to form a plurality of conductive through holes. An antenna excitation hole having an inner-surface electrode is provided so as to extend from one surface of the dielectric block to the opposing surface thereof. The dielectric block has, on the outer surface thereof, an outer conductor, an input terminal, an output terminal, and an antenna terminal. The input terminal, the output terminal, and the antenna terminal are separated from the outer conductor, and the antenna terminal is electrically coupled with the antenna excitation hole. The absolute value of the reflection coefficient of at least one of the input terminal, the output terminal, and the antenna terminal is in the range of about 0.33 to about 1.00 in a passband, with a reference impedance of 50 Ω. This arrangement allows impedance matching with an element to be connected to the dielectric duplexer, and allows low-loss transmission of a signal.

Preferably, the input impedance of the input terminal is set to 25 Ω or less. This arrangement allows impedance matching with a low-impedance circuit element at the earlier stage, and allows low-loss input of a signal from the earlier stage without inserting a matching circuit.

Preferably, the output impedance of the output terminal is set to 100 Ω or more. This arrangement allows impedance matching with a high-impedance circuit element at the subsequent stage, and allows low-loss output of a signal to the subsequent stage without inserting a matching circuit

Preferably, the input/output impedance of the antenna terminal is set to either 25 Ω or less or 100 Ω or more. This arrangement allows impedance matching with an antenna, and also allows for a reduction in loss at the time of transmission and an improvement in sensitivity at the time of reception.

Preferably, the dielectric duplexer further includes an excitation hole having an inner-surface electrode that is electrically coupled with the input terminal or the output terminal. The mutual capacitance between the excitation hole and the conductive through hole adjacent thereto is set by adjusting the shape of the excitation hole and the distance between the excitation hole and the conductive through hole adjacent thereto, and the input impedance or the output impedance is set based on the mutual capacitance. This arrangement can facilitate provision of a desired input impedance or output impedance.

Preferably, the inner conductor of one of the conductive through holes is electrically coupled with the input terminal or the output terminal, and the conductive through hole provides a resonator. The self-capacitance of the resonator is preferably set by adjusting the shape of the conductive through and the distance between the conductive through hole and the outer conductor. The input impedance or the output impedance is set based on the self-capacitance. This arrangement can facilitate provision of a desired input impedance or output impedance.

Capacitive coupling is provided between at least one of the conductive through holes and the input terminal or the output terminal. Preferably, the coupling capacitance therebetween is set by adjusting the shape and the position of the input terminal or the output terminal, and the input impedance or the output impedance is set based on the coupling capacitance. This arrangement can facilitate provision of a desired input impedance or output impedance.

According to another aspect of the present invention, there is provided a communication device that includes the dielectric duplexer. This arrangement can facilitate configuration of a low-loss and compact communication device.

### BRIEF DESCRIPTION OF THE DRAWINGS

FIG. 1 is a perspective view of a dielectric duplexer according to a first embodiment;

FIG. 2 is a circuit diagram of the input terminal section of the dielectric duplexer according to the first embodiment;

FIG. 3 is a graph showing the mutual impedance Zr between an excitation hole and an adjacent resonator versus input impedance Zin;

FIG. 4 is a circuit diagram of the output terminal section of the dielectric duplexer according to the first embodiment;

FIG. 5 is a block diagram of a communication device incorporating the dielectric duplexer according to the first embodiment;

FIG. 6 is a perspective view of a dielectric duplexer according to a second embodiment;

FIG. 7 is a block diagram of a communication device incorporating the dielectric duplexer according to the second embodiment;

FIG. 8 is a perspective view of a dielectric duplexer according to a third embodiment;

FIG. 9 is a block diagram of a communication device incorporating the dielectric duplexer according to the third embodiment;

FIG. 10 is a perspective view of a dielectric duplexer according to a fourth embodiment;

FIGS. 11A and 11B are each a circuit diagram of the output terminal section of the dielectric duplexer according to the fourth embodiment;

FIG. 12 is a graph showing the coupling capacitance between an output terminal and a resonator for coupling therewith versus output impedance; and

FIGS. 13A and 13B are block diagrams showing communication devices of the related art.

### DESCRIPTION OF THE PREFERRED EMBODIMENTS

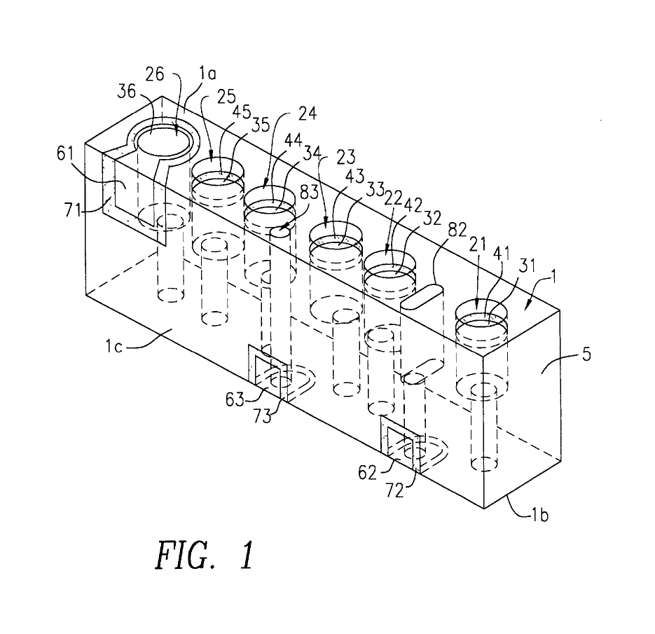

The configuration of a dielectric duplexer according to a first embodiment of the present invention will now be described with reference to FIG. 1.

In FIG. 1, in a dielectric block 1, holes 21 to 26, inner conductors 31 to 36, formed on respective inner surfaces of the holes 21 to 26 conductor-less portions 41 to 45, an outer conductor 5, an output terminal (RX terminal) 61, an input terminal (TX terminal) 62, an antenna terminal (ANT terminal) 63, conductor-less portions 71 to 73, and excitation holes 82 and 83 are provided. The holes 21 to 26 and the inner conductor 31 to 36 form a plurality of conductive through holes.

The dielectric block 1 preferably has a substantially rectangular shape. The conductive through holes 21 to 26, each preferably have a stepped-hole structure in which the inner diameter varies at substantially the middle thereof. The excitation holes 82 and 83, each having an inner-surface electrode, are provided in the same axial direction as the conductive through holes 21 to 26. The excitation hole 82 preferably has a stepped-hole structure, and the excitation hole 83 preferably has a straight-hole structure. The excitation hole 82 is preferably provided between the conductive through holes 21 and 22, and the excitation hole 83 is preferably provided between the conductive through holes 23 and 24.

The outer conductor 5 is formed on the. outer surface of the dielectric block 1. Each conductor-less portion 41 to 45 is preferably provided at the larger inner-diameter side of the respective conductive through hole 21 to 25. With this arrangement, the inner-conductors 31 to 35 and the outer conductor 5 are separated from each other to provide open-circuit ends. The smaller diameter side of the conductive through holes 21 to 25 is short circuited to the outer conductor 5 to form short circuited ends. The conductive through holes 21 to 25 each provide a dielectric resonator within the dielectric block 1. The excitation hole 82, which has an inner-surface electrode, is interdigitally coupled with the resonators that are provided by the adjacent conductive through holes 21 and 22. The excitation hole 83, which has an inner-surface electrode, is interdigitally coupled with the resonators that are provided by the adjacent conductive through holes 23 and 24.

A conductor-less portion is not provided in the conductive through hole 26, instead a conductor-less portion 71 is provided from the surface 1a, in which the open circuited ends of the conductive through holes 21 to 25 are provided, to a mounting surface 1c. This provides the open-circuited end of the inner conductor 36. An electrode provided at the open end of the inner conductor 36 serves as the output terminal 61 of the dielectric duplexer of FIG. 1.

On the outer surface of the dielectric block 1, conductor-less portions 72 and 73 are provided from the short-circuited surface 1b to the mounting surface 1c such that the input terminal 62 and the antenna terminal 63 are formed so as to be separated from the outer conductor 5. The input terminal 62 is electrically coupled with the inner-surface electrode in the excitation hole 82, and the antenna terminal 63 is electrically coupled with the inner-surface electrode in the excitation hole 83.

With this arrangement, the two resonators provided by the conductive through holes 22 and 23, the input terminal 62, and the antenna terminal 63 constitute a dielectric filter. The three resonators provided by the conductive through holes 24 to 26, the output terminal 61, and the antenna terminal 63 constitute another dielectric filter. The resonator provided by the conductive through hole 21 acts as a trap resonator. In this manner, this dielectric duplexer is configured such that the two-stage dielectric filter and the trap resonator constitute a transmitting filter and the three-stage dielectric filter constitutes a receiving filter.

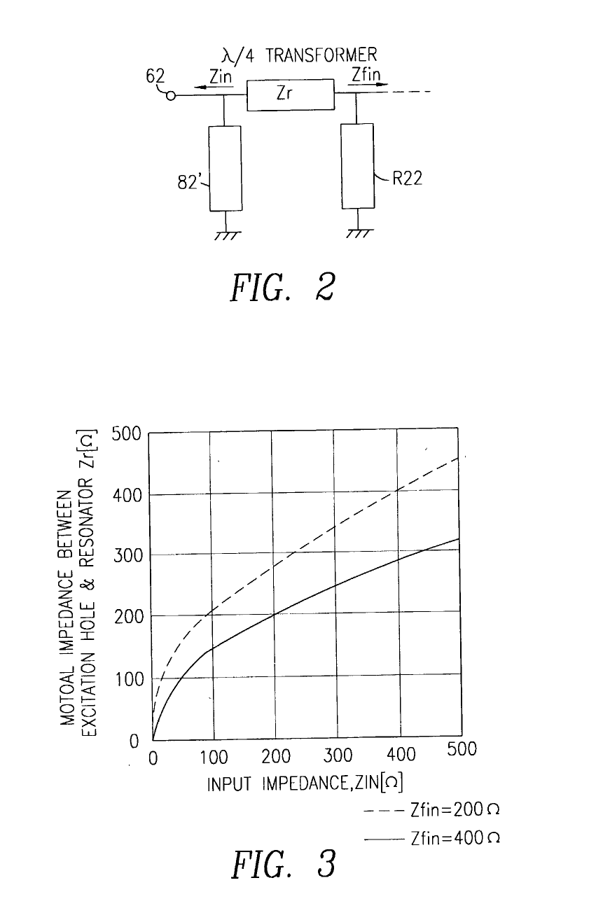

The coupling between the excitation hole 82 and the resonator provided by the adjacent inner conductor 32 is interdigital coupling, and this arrangement can be regarded as a transmission line having an equivalent impedance of Zr as shown in FIG. 2. That is, this is a kind of ¼ wavelength transformer (an impedance converter). In FIG. 2, reference numeral R22 indicates the resonator provided by the conductive through hole 22, and 82′ indicates an element provided by the excitation hole 82. Reference symbol Zin indicates an input impedance when viewed from the input terminal 62. Zfin is an input impedance when viewed from the resonator provided by the conductive through hole 22, and Zr is the impedance of the ¼ wavelength transformer.

The following expression is satisfied with respect to the impedances:

Zr=(Zin×Zfin)^{½}

wherein impedance conversion is performed between Zin and Zfin.

Thus, the input impedance Zin is given by:

Zin=Zr²/Zfin

In this case, when the diameter of the excitation hole 82 is increased, the longitudinal diameter of the ellipse is increased, or the distance between the excitation hole 82 and the resonator provided by the adjacent conductive through hole 32 is reduced, the mutual capacitance is increased and thus Zr is reduced.

FIG. 3 is a graph showing the mutual impedance Zr between the excitation hole and the adjacent resonator versus the input impedance Zin.

As shown in FIG. 3, when the input impedance Zfin from the resonator R22 is constant, the input impedance Zin decreases as the mutual impedance Zr decreases.

In this manner, the input impedance of the transmitting filter in the dielectric duplexer can be reduced.

Thus, configuring the transmitting filter as described above such that the input impedance becomes 25 Ω or less can provide a reflection coefficient of about −0.33 or less (0.33 or more in absolute value) for the input terminal, with a reference impedance of 50 Ω. This allows low-loss transmission of a signal even when the dielectric duplexer is directly connected to a low output-impedance circuit element, such as a power amplifier.

With regard to the output terminal 61, since the output terminal 61 also serves as the open circuited end of the resonator that is provided by the conductive through hole 26 constituting the receiving filter, the output impedance of the receiving filter directly becomes the output impedance of the output terminal 61.

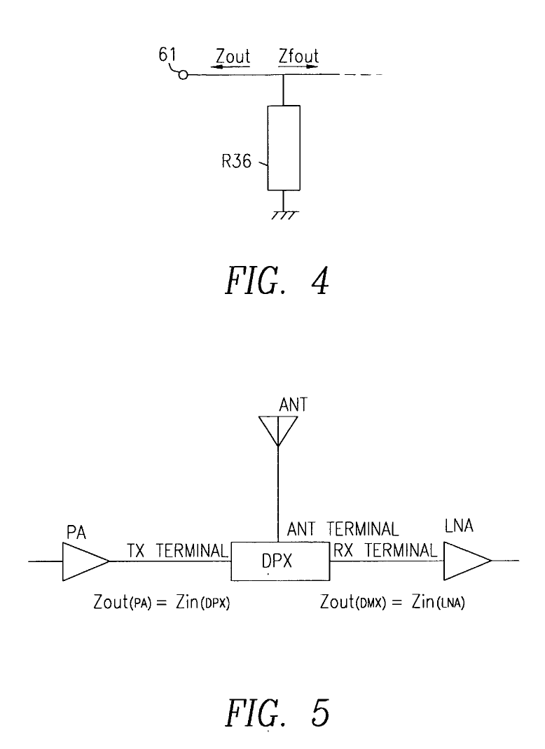

FIG. 4 shows an equivalent circuit of the output terminal 61 and the resonator R36 provided by the conductive through hole 26 that is electrically coupled with the output terminal 61. In FIG. 4, reference symbol Zout indicates the output impedance of the output terminal 61 and Zfout indicates the output impedance of the transmitting filter.

The output impedance Zfout of the filter is expressed by:

Zfout=4×Za×Qe/π(=Zout)

where Za is the self-impedance of the resonator R36, and Qe is the external Q-factor of the filter.

Thus, increasing the self-impedance Za of the resonator R36 can increase the output impedance of the output terminal 61.

Increasing the self-capacitance of the resonator R36 can increase the self-impedance Za of the resonator R36. That is, increasing the distance between the conductive through hole 26 and the outer conductor 5, or reducing the inner diameter of the conductive through hole 26 can increase the self-impedance Za.

By way of an example, when the filter according to this embodiment is designed to have a bandwidth ratio of 40 and a Q-factor Qe of about 20, the following expression is given:

Zout˜25.5×Za

In general, in a small dielectric filter, since the self-impedance of the resonator is about 5 to 15 Ω, the output impedance Zout becomes about 130 to 380 Ω. In this manner, changing the structure of the resonator that is electrically coupled with the output terminal 61 allows for setting of the output impedance to 100 Ω or more. This can provide a high output-impedance for the transmitting filter in the dielectric duplexer.

Thus, configuring the receiving filter as described above such that the output impedance becomes 100 Ω or more can provide a reflection factor of about +0.33 or more for the output terminal, with a reference impedance of 50 Ω. This allows low-loss transmission of a signal even when the dielectric duplexer is directly connected to a high input-impedance circuit element, such as a low-noise amplifier LNA.

In addition, adjusting the inner diameter of the excitation hole 83, which preferably has a straight-hole structure, allows for setting such that matching is achieved with the input/output impedance of the antenna terminal.

Typically, the characteristic impedance of antennas is set to 50 Ω. In some cases, the impedance may not be the intrinsic impedance of elements that constitute the antennas and may be converted into 50 Ω. However, such impedance conversion into 50 Ω causes generation of loss that is due to a converter circuit. Thus, changing the structures of an antenna terminal and a resonator for coupling therewith can provide a desired input/output impedance.

With this arrangement, a connection can be accomplished with an impedance that can increase the gain of the antenna, which thus can enhance the sending and receiving efficiencies.

In addition, when the impedance of a circuit element to be connected to the dielectric duplexer is either 25 Ω or less or 100 Ω or more, varying the shape of the excitation hole or the resonator allows for matching of the input impedance and the output impedance. In other words, varying the configuration of the dielectric duplexer such that the absolute value of the reflection factor falls in the range of about 0.33 to about 1.00 allows for direct and low-loss transmission of a signal to/from a circuit element that is connected prior to/subsequent to the input/output terminal and that has an impedance of either 25 Ω or less or 100 Ω or more.

The use of this dielectric duplexer allows for configuration of a communication device as shown in FIG. 5.

In FIG. 5, reference symbol DPX is a duplexer, PA is a power amplifier, ANT is an antenna, and LNA is a low-noise amplifier.

In this case, the output impedance of the power amplifier PA is 25 Ω or less, the input impedance of the low-noise amplifier LNA is 100 Ω or more, and the input/output impedance of the antenna ANT is 50 Ω.

A signal amplified by the power amplifier PA is converted by the duplexer DPX into a transmission wave having a signal within a frequency band. The transmission wave is then sent to the antenna ANT for transmission. The signal received by the antenna ANT is filtered by the duplexer DPX into a signal within a frequency band required by a circuit at a subsequent stage, and is sent to the low-noise amplifier LNA. The low-noise amplifier LNA amplifies the received wave and sends the resulting signal to a circuit at the subsequent stage. Incorporating the dielectric duplexer of the first embodiment, shown in FIG. 1, in such a communication device allows impedance matching between the individual elements without inserting a matching circuit between the power amplifier PA and the dielectric duplexer DPX, and without inserting a matching circuit between the dielectric duplexer DPX and the low-noise amplifier LNA. This can therefore improve the reception sensitivity of a signal.

Such a configuration, without the use of a matching circuit, can provide a compact and low-loss communication device.

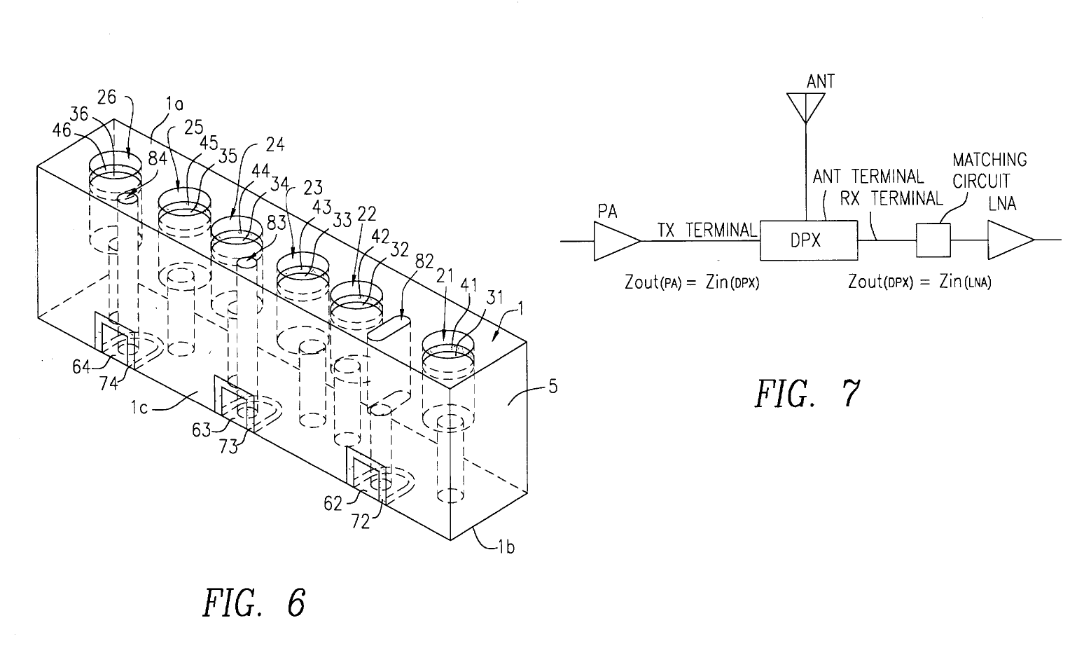

The configuration of a dielectric duplexer according to a second embodiment will now be described with reference to FIG. 6.

In FIG. 6, in the dielectric block 1, conductive through holes 21 to 26 having inner conductors 31 to 36, conductor-less portions 41 to 46, an outer conductor 5, an output terminal (RX terminal) 64, an input terminal (TX terminal) 62, an antenna terminal (ANT terminal) 63, no-outer-conductor portions 72 to 74, and excitation holes 82 to 84 are provided.

As shown in FIG. 6, in the conductive through hole 26, the conductor-less portion 46 is provided similar to the other conductive through holes 21 to 25. The inner conductor 36 provides a resonator in cooperation with the dielectric block 1 and the outer conductor 5. The conductor-less portion 74 is provided from the short-circuited surface 1b to the mounting surface 1c such that the output terminal 64 is formed. The output terminal 64 is electrically coupled with the inner-surface electrode of the excitation hole 84. The excitation hole 84 is preferably provided in the same axial direction as the conductive through holes 21 to 26, and preferably has a straight-hole structure. The excitation hole 84 is also preferably provided between the conductive through holes 25 and 26, and is interdigitally coupled with resonators provided by the conductive through holes 25 and 26. The resonator provided by the conductive through hole 26 is electrically coupled with the excitation hole 84, so as to form a trap resonator. Other elements are analogous to those of the dielectric duplexer according to the first embodiment shown in FIG. 1.

With this arrangement, two resonators provided by the conductive through holes 22 and 23, the trap resonator provided by the conductive through hole 21, the input terminal 62, and the antenna terminal 63 constitute a transmitting filter. That is, a two-stage resonator and a trap resonator constitute a transmitting filter. The two resonators provided by the conductive through holes 24 and 25, the trap resonator provided by the conductive through hole 26, the output terminal 64, and the antenna terminal 63 constitute a receiving filter. That is, a two-stage resonator and a trap resonator constitute a receiving filter. Thus, the transmitting filter and the receiving filter constitute the dielectric duplexer of the second embodiment.

In this case, increasing the diameter of the excitation hole 82, increasing the longitudinal diameter of the ellipse, or reducing the distance between the excitation hole 82 and the resonator provided by the conductive through hole 22 can reduce the input-impedance. In addition, reducing the inner diameter of the excitation hole 84, which preferably has a straight-hole structure, can increase the output impedance of the output terminal 64.

With this structure, the input impedance of the input terminal 62 is matched with the output impedance of a low-impedance circuit element to be connected externally. This can therefore achieve impedance matching between the two elements without providing a matching circuit.

In this case, reducing the inner diameter of the excitation hole 84 can increase the output impedance of the output terminal 64.

The use of this dielectric duplexer allows for configuration of a communication device as shown in FIG. 7.

FIG. 7 is a block diagram of a communication device, in which a matching circuit is inserted between a duplexer DPX and a low-noise amplifier LNA. Other configurations are analogous to those of the communication device shown in FIG. 5.

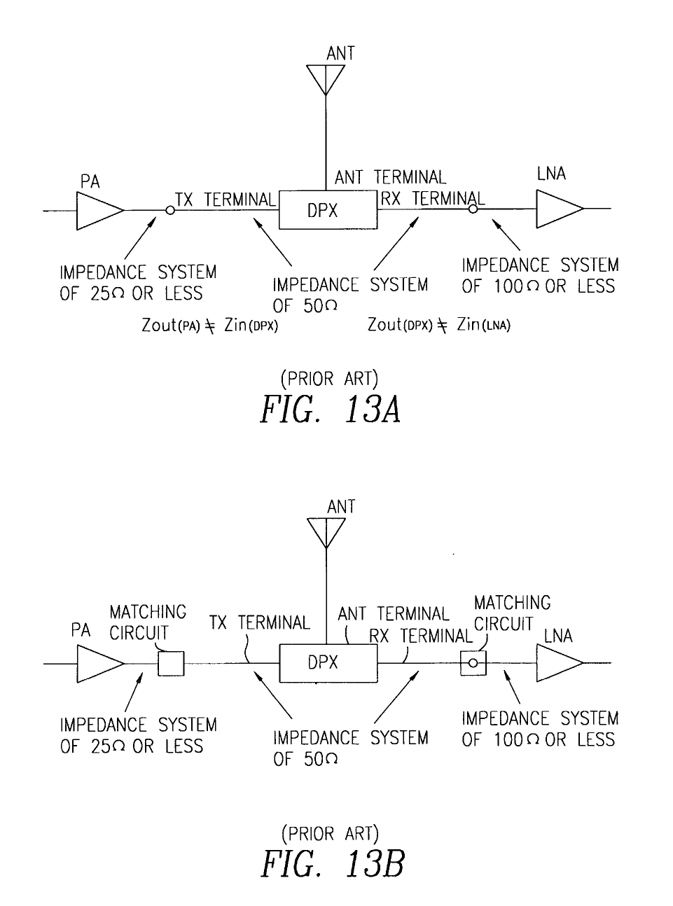

To obtain a passing characteristic necessary for the receiving side of the duplexer DPX, the structure having the output terminal and the conductive through holes, as shown in FIG. 1, cannot be adopted. As shown in FIG. 7, however, a matching circuit may be provided between the output terminal and the low-noise amplifier LNA (a high-impedance circuit element) at the subsequent stage. With this arrangement, since there is no need for a matching circuit between the duplexer DPX and the power amplifier PA, the number of circuit elements can be reduced compared to the communication device of the related art shown in FIG. 13B, so that the communication device of this embodiment can be miniaturized. Additionally, since no matching circuit is inserted in the stage prior to the input terminal, this arrangement can prevent the generation of loss due to that matching circuit.

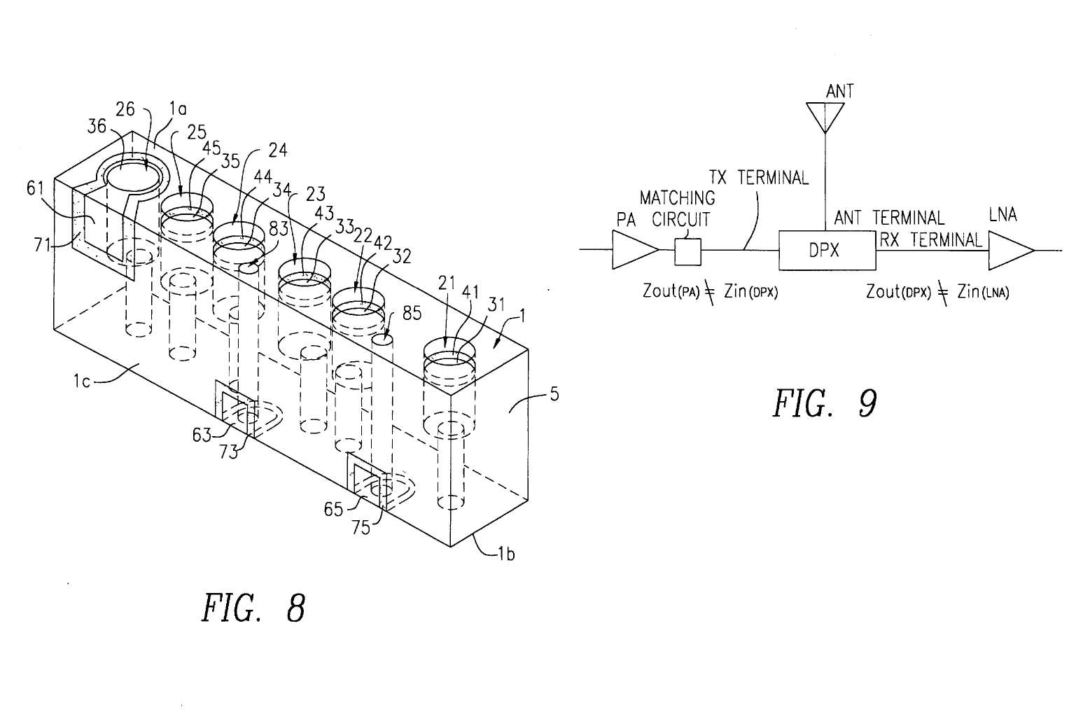

The configuration of a dielectric duplexer according to a third embodiment will now be described with reference to FIG. 8.

In FIG. 8, in a dielectric block 1, conductive through holes 21 to 26 with inner conductors 31 to 36, conductor-less portions 41 to 45, an outer conductor 5, an output terminal (RX terminal) 61, an input terminal (TX terminal) 65, an antenna terminal (ANT terminal) 63, conductor-less portions 71, 73, and 75, and excitation holes 83 and 85 are provided.

The dielectric duplexer of the embodiment shown in FIG. 8 is provided with a conductor-less portion 75 from the short-circuited surface 1b to the mounting surface 1c such that the output terminal 65 is formed. The output terminal 65 is electrically coupled with the inner-surface electrode of the excitation hole 85, which preferably has a straight-hole structure. The excitation hole 85 is preferably provided between the conductive through holes 21 and 22. Other configurations are analogous to those of the dielectric duplexer of the first embodiment shown in FIG. 1.

With this structure, since the output terminal 61 is electrically coupled with the inner conductor 36 of conductive through hole 26, the output impedance can be increased in the same manner described above. Thus, the output impedance of the dielectric duplexer can be matched with the input impedance of a high-impedance circuit element to be connected thereto. Thus, impedance matching can be achieved without providing a matching circuit between the output terminal 61 of the dielectric duplexer and a circuit element connected thereto.

Meanwhile, increasing the inner diameter of the excitation hole 85 or bringing it into closer proximity to the conductive through hole 22 can reduce the input impedance of the input terminal 65.

The use of this dielectric duplexer allows for configuration of a communication device as shown in FIG. 9.

FIG. 9 is a block diagram of a communication device, in which a matching circuit is inserted between a power amplifier PA and a duplexer DPX. Other elements are analogous to those of the communication device shown in FIG. 5.

To obtain a passing characteristic necessary for the transmitting side of the duplexer, the structure having the input terminal (TX terminal) 62 and the excitation hole 82 as shown in FIG. 1 cannot be adopted. As shown in FIG. 8, however, a matching circuit may be provided between the input terminal (TX terminal) and the power amplifier PA (a low-impedance circuit element) connected thereto, so that a matching circuit does not have to provided between the output terminal (RX terminal) and a high-impedance circuit element connected thereto. Thus, the number of circuit elements can be reduced compared to the communication device of the related art shown in FIG. 13B. In addition, since no matching circuit is connected to the output terminal (RX terminal), the generation of loss due to the inserted matching circuit is prevented.

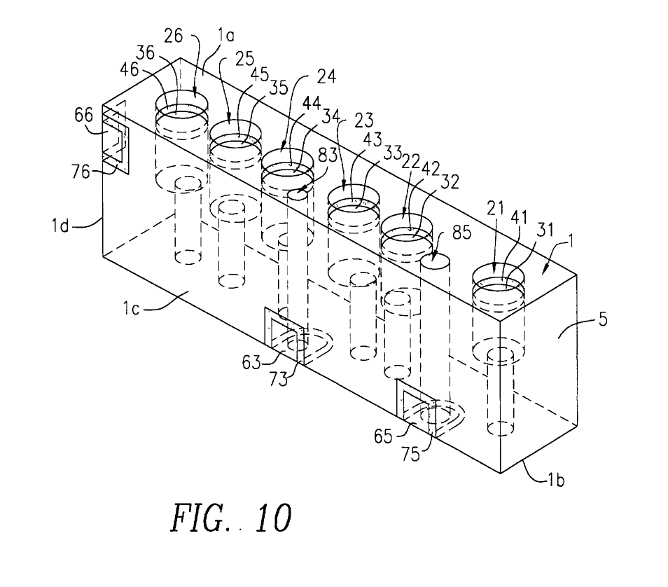

The configuration of a dielectric duplexer according to a fourth embodiment will now be described with reference to FIGS. 10 to 12.

In FIG. 10, in a dielectric block 1, conductive through holes 21 to 26 having inner conductors 31 to 36, conductor-less portions 41 to 46, an outer conductor 5, an output terminal (RX terminal) 66, an input terminal (TX terminal) 65, an antenna terminal (ANT terminal) 63, conductor-less portions 73, 75, and 76, and excitation holes 83 and 85 are provided.

The dielectric block 1 preferably has substantially rectangular shape. The conductive through holes 21 to 26 each preferably have a stepped-hole structure in which the inner diameter varies at substantially the middle thereof. The excitation holes 83 and 85, each having an inner-surface electrode and preferably having a straight-hole structure, are also provided in the same axial direction as the conductive through holes 21 to 26. The inner diameter of the excitation hole 83 is preferably smaller than that of the excitation hole 85. The excitation hole 83 is preferably provided between the conductive through hole 23 and the conductive through hole 24, and the excitation hole 85 is preferably provided between the conductive through holes 21 and 22.

The outer conductor 5 is formed on the outer surface of the dielectric block 1. Each conductor-less portion 41 to 46 is preferably provided at the larger inner-diameter side of the respective conductive through holes 21 to 26. The conductor-less portions 41 to 46 form open circuited ends of the conductive through holes 21 to 26, respectively. The smaller diameter side of the respective conductive through holes 21 to 26 are short-circuited to the outer conductor 5 to form short circuited ends.

Thus, the conductive through holes 21 to 26 provide dielectric resonators in cooperation with the dielectric block 1 and the outer conductor 5. The excitation hole 85 is interdigitally coupled with resonators that are provided by the adjacent conductive through holes 21 and 22, and the excitation hole 83 is interdigitally coupled with resonators provided by the adjacent conductive through holes 23 and 24.

The conductor-less portions 73 and 75 are provided from the short-circuited surface 1b to the mounting surface 1c on the outer surface of the dielectric block 1 such that the antenna terminal 63 and the input terminal 65 are formed. The input terminal 65 is electrically coupled with the inner-surface electrode of the excitation hole 85, and the antenna terminal 63 is electrically coupled with the inner surface of the excitation hole 83. The conductor-less portion 76 is provided from an end surface 1d (the left back surface in FIG. 10) to the mounting surface 1c such that the output terminal 66 is formed.

With this arrangement, the two resonators provided by the conductive through holes 22 and 23, the input terminal 65, and the antenna terminal 63 constitute a dielectric filter. The three resonators provided by the conductive through holes 24 to 26, the output terminal 66, and the antenna terminal 63 constitute another dielectric filter. The resonator provided by the conductive through hole 21 acts as a trap resonator. That is, this dielectric duplexer is configured such that a two-stage resonator and a trap resonator constitute a transmitting filter and a three-stage resonator constitutes a receiving filter.

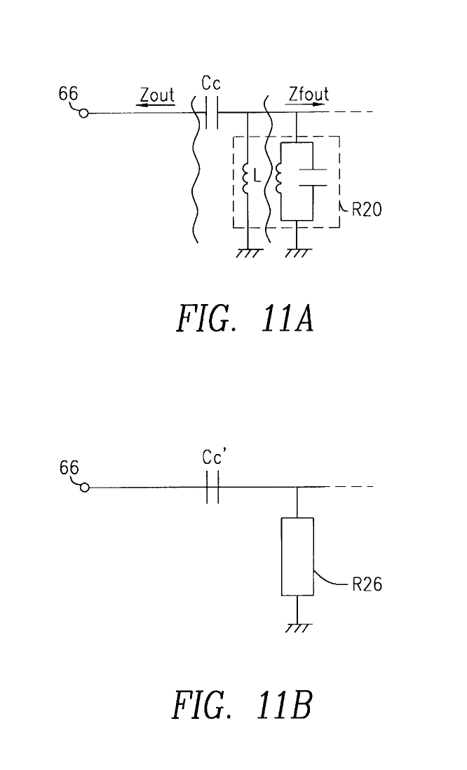

As shown in FIG. 11A, a coupling capacitance Ce is generated between the output terminal 66 and the resonator R26 provided by the conductive through hole 26 in the dielectric duplexer.

In FIG. 11A, Zout is an output impedance when viewed from the output terminal 66, Zfout is an output impedance when viewed from the resonator R26, and L is an inductance component of the resonator R26.

As shown in FIG. 11B, in combination with the inductance component L of the resonator R26, the impedance of the coupling capacitance Ce is converted to Ce′. In this case, the relationship of the output impedances Zout and Zfout and the coupling capacitance Ce is expressed by:

Ce′=1/(ω×(Zout×(Zfout-Zout))^{½})

where ω is the angular frequency of the resonant frequency.

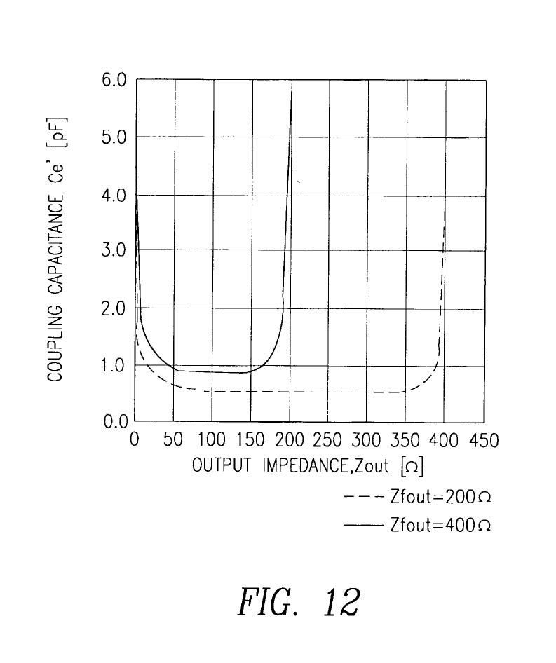

Based on this expression, the relationship between the coupling capacitance Ce′ and the output impedance Zout is shown in FIG. 12.

As shown in FIG. 12, varying the coupling capacitance Ce′ allows for arbitrary setting of the output impedance Zout. That is, the shape and position of the output terminal 66 defines the coupling capacitance Ce between the output terminal 66 and the resonator R26. Thus, the output impedance Zout can be set high so as to match that of a high-impedance circuit element at the subsequent stage.

In this case, since the output impedance Zout cannot be set greater than the output impedance Zfout, it is adjusted within the range of 0<Zout<Zfout.

The excitation hole 85 connected to the input terminal 65 is analogous to the excitation hole 85 of the third embodiment.

With this arrangement, therefore, the output impedance of the dielectric duplexer can be set so as to match the impedance of a circuit element connected to the output terminal 66.

In the above embodiments, the input impedance and output impedance are adjusted by varying the structure of the input or output terminal or by varying the shape and/or position of the excitation holes or resonators that are in continuity with the terminals. The same approach can be equally applied to the antenna terminal.

With regard to the input terminal and the output terminal to which description has been separately given in the above embodiments, the configuration thereof may be such that the input terminal and the output terminal are reversed depending upon the impedances of circuit elements to be connected to the corresponding terminals.

What is claimed is:

1. A dielectric duplexer comprising:
a dielectric block having a first surface and a second surface opposite the first surface;
a plurality of conductive through holes provided in the dielectric block, each conductive through hole extending from the first surface of the dielectric block to the opposite second surface;
an antenna excitation hole provided in the dielectric block, the antenna excitation hole extending from the first surface of the dielectric block to the opposite second surface;
an outer conductor provided on an outer surface of the dielectric block;
an input terminal provided on the outer surface of the dielectric block and separated from the outer conductor;
an output terminal provided on the outer surface of the dielectric block and separated from the outer conductor; and
an antenna terminal provided on the outer surface of the dielectric block, separated from the outer conductor and electrically coupled with the antenna excitation hole,
wherein an absolute value of a reflection coefficient of at least one of the input terminal, the output terminal, and the antenna terminal is in the range of about 0.33 to about 1.00 in a passband, with a reference impedance of 50 Ω.

2. The dielectric duplexer according to claim 1, wherein an input impedance of the input terminal is 25 Ω or less.

3. The dielectric duplexer according to claim 1, wherein an output impedance of the output terminal is 100 Ω or more.

4. The dielectric duplexer according to claim 1, wherein an impedance of the antenna terminal is one of 25 Ω or less and 100 Ω or more.

5. The dielectric duplexer according to claim 2, further comprising an excitation hole electrically coupled with the input terminal, wherein a mutual capacitance between the excitation hole and a conductive through hole adjacent thereto is set by adjusting a shape of the excitation hole and a distance between the excitation hole and the adjacent conductive through hole, and the input impedance is set based on the mutual capacitance.

6. The dielectric duplexer according to claim 3, wherein one of the conductive through holes is electrically coupled with the output terminal, and wherein a self-capacitance of the one conductive through hole is set by adjusting a shape of the one conductive through hole and a distance between the one conductive through hole and the outer conductor, and the output impedance is set based on the self-capacitance.

7. The dielectric duplexer according to claim 2, wherein capacitive coupling is provided between one of the conductive through holes and the input terminal, the coupling capacitance therebetween being set by adjusting a shape and a position of the input terminal, and the input impedance is set based on the coupling capacitance.

8. The dielectric duplexer according to claim 3, wherein capacitive coupling is provided between one of the conductive through holes and the output terminal, the coupling capacitance therebetween being set by adjusting a shape and a position of the output terminal, and the output impedance is set based on the coupling capacitance.

9. The dielectric duplexer according to claim 3, further comprising an excitation hole electrically coupled with the output terminal, wherein a mutual capacitance between the excitation hole and a conductive through hole adjacent thereto is set by adjusting a shape of the excitation hole and a distance between the excitation hole and the adjacent conductive through hole, and the output impedance is set based on the mutual capacitance.

10. The dielectric duplexer according to claim 2, wherein one of the conductive through holes is electrically coupled with the input terminal, and wherein a self-capacitance of the one conductive through hole is set by adjusting a shape of the one conductive through hole and a distance between the one conductive through hole and the outer conductor, and the input impedance is set based on the self-capacitance.

11. The dielectric duplexer according to claim 3, wherein capacitive coupling is provided between one of the conductive through holes and the output terminal, the coupling capacitance therebetween being set by adjusting a shape and a position of the output terminal, and the output impedance is set based on the coupling capacitance.

12. The dielectric duplexer according to claim 2, wherein capacitive coupling is provided between one of the conductive through holes and the input terminal, the coupling capacitance therebetween being set by adjusting a shape and a position of the input terminal, and the input impedance is set based on the coupling capacitance.

13. A communication device comprising a dielectric duplexer according to claim 1.
